(19) United States
(12) Patent Application Publication
(10) Pub. No.: US 2004/0043197 A1
(43) Pub. Date: Mar. 4, 2004

(54) Low dielectric constant insulating material, and electronic part

(75) Inventor: Azuma Matsuura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Fujitsu Limited, Kawasaki (JP)

(21) Appl. No.: 10/650,761

(22) Filed: Aug. 29, 2003

(30) Foreign Application Priority Data
Aug. 30, 2002 (JP) 2002-252834

(51) Int. Cl. B32B 3/00

(52) U.S. Cl. 428/190; 428/297.1

(57) ABSTRACT

The present invention aims to provide a low dielectric constant insulating material which enables high-speed propagation of signals and is suitable as a material for multilayer circuit wires in an electronic part such as a semiconductor element or the like. The low dielectric constant insulating material of the present invention has an atom having a valency of four or more, and at least two cyclic compounds form a cyclic structure with the atom. Aspects such as that the atom having a valency of four or more is one of a carbon atom, a silicon atom, a nitrogen atom, a phosphor atom and a sulfur atom, that the atom having a valency of four or more is a spiro atom, that the atom having a valency of four or more is in sp3 valency state, and the like are preferable.

### CROSS-REFERENCE TO RELATED APPLICATIONS

This application is based upon and claims the benefits of the priority from the prior Japanese Patent Application No. 2002-252834, filed on Aug. 30, 2002, the entire contents of which are incorporated herein by reference.

### BACKGROUND OF THE INVENTION

1. Field of the Invention

The present invention relates to a low dielectric constant insulating material, which contributes to the high speed propagation of signals and which is suitable as a material for multilayer circuit wires in electronic parts such as semiconductor elements and the like. Moreover, the present invention also relates to an electronic part using the same.

2. Description of the Related Art

Semiconductor elements used in various types of computers from personal computers to high-performance computers have become remarkably high-speed in recent years. In such semiconductor elements, the transfer delay at the substrate wire portions relatively affects the computational speed of the computer. Thus, thin resin wirings, which are suitable for the formation of highly-dense and fine multilayer wirings, have gradually come to be applied as materials for interlayer insulating films and circuit boards for CPUs of various types of computers. In order to realize high-speed computers, it is required to obtain highly-dense and fine multilayer wirings, and to develop a low dielectric constant insulating material suitable for high-speed propagation of signals and use the low dielectric constant insulating material as an interlayer insulating film. Conventionally, SiO₂ inorganic materials have been widely used as the material for interlayer insulating films in high-speed computers. However, recently, organic materials, which are heat resistant and whose dielectric constant is fundamentally lower than that of inorganic materials, have been studied.

Generally, the dielectric constant “∈” of a non-polar condensed system is expressed by the following Clausius-Mosotti equation, in consideration of the local field:

$$\frac{ϵ - 1}{ϵ + 2} = \frac{4 π}{3} α N$$

where “α” is the electronic polarizability of the material molecules, and “N” is the number of molecules per unit volume.

FIG. 1 is a graph showing the relationship between “αN” and the dielectric constant “∈”. As shown in FIG. 1, the smaller the polarizability “α” of the material or the smaller the number of molecules “N” per unit volume is, the smaller the dielectric constant “∈” is.

On the other hand, given that the dipole moment induced by an electric field “Ε” is “μ”, the polarizability “α” of the material is defined by the following formula.

μ=αΕ

In the formula, “μ” and “Ε” are vector quantities, and “α” is a second-rank tensor quantity. Accordingly, “α” has “3×3=9” elements. However, generally, the average polarizability “αₐᵥ” is defined as follows, and is used as a scalar quantity.

$${α}_{av} = \frac{{α}_{xx} + {α}_{yy} + {α}_{zz}}{3}$$

From the relationship between the electric field and the induced dipole, it can be understood that materials, which generate larger dipoles in smaller electric fields, have higher polarizabilities. In other words, the more electrons, which can easily move within a material, exist, the higher the polarizability is.

Conventionally, in order to keep the dielectric constant low, the utilization of fluorine resin has been studied for keeping the polarizability low. Fluorine resins generally have many saturated bonds in their composition and contain fluorine atoms having high electronegativity. Thus, there are only few electrons, which can freely move, existed therein, and the dielectric constant is therefore low. However, it is known that, when fluorine resins are used, the dielectric constant is not lower than 2. Accordingly, fluorine resins are insufficient from the standpoint of the dielectric constant, and fluorine resins are also problematic with respect to moisture-resistance, autohesion, adhesion to conductive metals, processability of via holes between the layers, and the like.

Meanwhile, there have been proposed methods for keeping the dielectric constant low by making the number of molecules per unit volume small, for example, by using a foamed material. However, in this case, the problem is arisen in that the material is not suitable for the material of interlayer insulating films having a wire width of the order of several tens of nano meters to several hundreds of nano meters, nor for use as a material for interlayer insulating films of fine wires relating to circuit boards on the order of several tens of micro meters.

Moreover, there have been proposed methods for keeping the dielectric constant low by forming spaces or voids at the molecular level, for example, by mixing fullerene, carbon nanotube or the like into a resin so as to form a composite material. However, fullerene and carbon nanotube are formed only from carbon, and with respect of solubility, only minute amounts thereof can be dissolved in limited solvents. Further, even if fullerene and carbon nanotube are mixed together with a resin, problems arise in that it is easy for phase separation to occur and is difficult to form a composite material.

### SUMMARY OF THE INVENTION

An object of the present invention is to provide a low dielectric constant insulating material which contributes to the high speed propagation of signals and which is suitable as a material for multilayer circuit wires in electronic parts such as semiconductor elements and the like. Further object of the present invention is to provide an electronic part using the low dielectric constant insulating material.

The low dielectric constant insulating material of the present invention comprises an atom having a valency of four more, and at least two cyclic compounds forming a cyclic structure with the atom having a valency of four or more. Since two cyclic compounds exist in the low dielectric constant insulating material, four spaces or voids are formed around the atom having a valency of four or more, by the two cyclic compounds. In other aspect, an aromatic compound, an insulating resin or the like bonds to the cyclic compound and two molecular chains are formed so that four spaces or voids are formed around the atom having a valency of four or more, by the two molecular chains. Thus the dielectric constant can be kept low in the low dielectric constant insulating material. Moreover, when an aromatic compound, an insulating resin or the like bonds to the cyclic compound in the low dielectric constant insulating material, a film formed of the low dielectric constant insulating material has enough strength to resist CMP (chemical mechanical polishing), excellent heat resistance, and the like. The low dielectric constant insulating material of the present invention is suitably used as a material for an interlayer insulating film in electronic parts such as semiconductor elements, and the like.

The electronic part of the present invention comprises the low dielectric constant insulating material. Thus, the electronic part exhibits excellent propagation of signals and extremely high-performance.

### BRIEF DESCRIPTION OF THE DRAWINGS

FIG. 1 is a graph showing the relationship between the dielectric constant “∈” and “αN” which is the product of the number of molecules per unit volume “N” and the polarizability “α”, based on the Clausius-Mosotti equation.

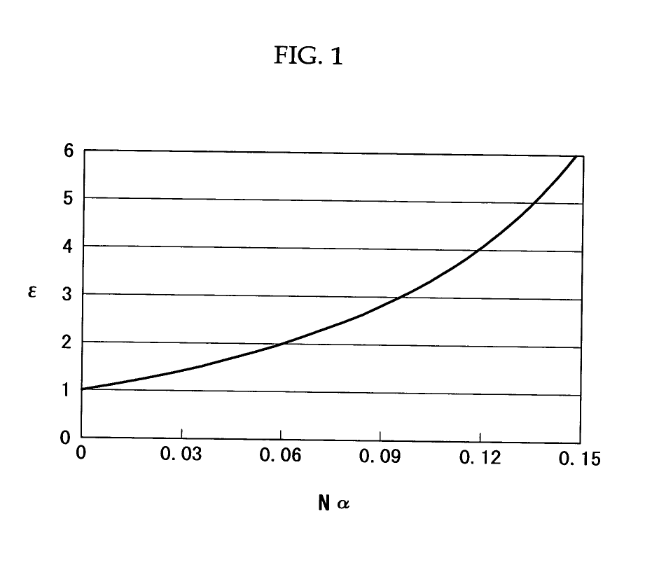

FIG. 2 is a schematic diagram showing one example of the molecular structure of the low dielectric constant insulating material of the present invention.

FIG. 3 is a schematic diagram showing one example of the three-dimensional molecular structure of the low dielectric constant insulating material of the present invention.

FIG. 4 is a schematic diagram showing one example of forming a network by using the low dielectric constant insulating material of the present invention.

### DESCRIPTION OF THE PREFERRED EMBODIMENTS

### Low Dielectric Constant Insulating Material

The low dielectric constant insulating material of the present invention contains an atom having a valency of four or more, and at least two cyclic compounds forming a cyclic structure with the atom.

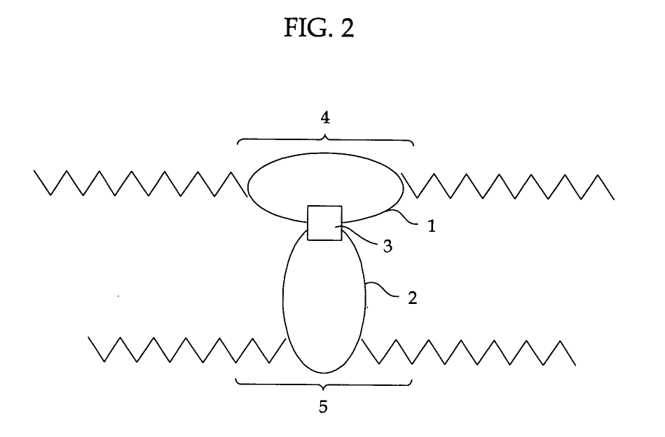

The atom having a valency of four or more are not particularly limited and can be appropriately selected in accordance with the object. Examples are a carbon atom, a silicon atom, a nitrogen atom, a phosphorus atom, a sulfur atom, and the like. Among these, as shown in FIG. 2, an atom capable of forming a four-sided structure with atoms bonded thereto is preferable due to the capability of making the two cyclic compounds “1” and “2”, which are within molecular chains “3” and “4”, orthogonal, and forming spaces around the atom “3” having a valency of four or more. Spiro atoms such as carbon atoms, silicon atoms, nitrogen atoms and the like are more preferable. Atoms in an sp3 valency state are particularly preferable, and specifically, carbon atoms are particularly preferable.

The cyclic compounds are not particularly limited as long as they can form a cyclic structure with the atom having a valence of four or more, and the cyclic compounds can be appropriately selected in accordance with the object. A suitable example is a compound having two benzene skeletons, each of which has a carbon atom at a portion thereof, and the carbon atom of one benzene skeleton bonds with the carbon atom of the other benzene skeleton.

One, two or more types of the cyclic compound which bonds with the atom having a valency of four or more may be used. Among these cyclic compounds, those having a skeleton expressed by the following Formula 1 are particularly preferable:

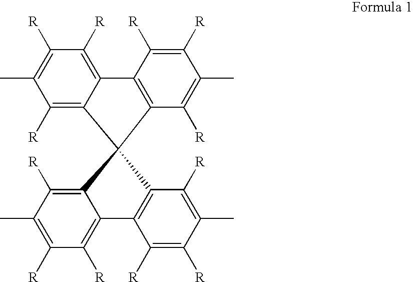

where “R” expresses a hydrogen atom or a substituent.

In the above Formula 1, an aromatic compound, an insulating resin, or the like may bond with the four terminals where the substituent “R” is not written. It is preferable that at least one of an aromatic compound and an insulating resin bonds with the four terminals, and it is more preferable that an aromatic compound essentially bonds with any of the four terminals, and an insulating resin also binds with any other of the four terminals.

The at least one of an aromatic compound and an insulating resin is not particularly limited and can be appropriately selected in accordance with the object. From the standpoints of being able to form a film or the like having excellent mechanical strength and heat resistance and the like, aromatic compounds and silicone resins are preferable, and at least one type selected from p-phenylene derivatives and silicone resins (heat-resistant silicone resins) is more preferable, and a compound in which a silicone resin is bonded to a p-phenylene derivative is particularly preferable from the standpoints of excellent heat resistance and strength.

The number of the cyclic compounds is determined by the type of an atom having a valency of four or more. If the atom is a carbon atom, a silicon atom, a nitrogen atom, a phosphorous atom, or the like, there are two cyclic compounds. If the atom is a sulfur atom, there are three cyclic compounds.

Specific examples of the low dielectric constant insulating material are 2,2′,7,7′tetraquis-[diphenylamino]-9,9′-spirobifluorene, 2,2′,7,7′tetra-[N-carbazolyl]-9,9′-spirobifluorene, 2λ6-spiro[[1,3,2]benzodioxathiol-2,2″-([1,2,3]benzoxadithiol)-2,5″-dibenzo[b,d]thiophene], 6-oxa-2,2′-spirobi[bicyclo[2.2.1]heptane]-5′-ene, dispiro[4.2.4.2]tetradecane, trispiro[2.2.2.29.26.23]pentadecane, dispiro[4.1.5.2]tetradecane, trispiro[2.2.26.2.211.23]pentadecane, pentaspiro[2.0.24.1.1.210.0.213.18.23]octadecane, 1H,1′H-2,2′-spirobi[naphathalene], 1H,1′H-2,4′-spirobi[quinoline], 1,1′-spirobi[indene], spiro[1H-indene-1,2′-[2H]indene], 3H,1″H-dispiro[1-benzofuran-2,2′-[1,3]dithioran-4′, 2″-quinoline], spiro[fluorene-9,2′-[3]thiabicyclo[2.2.2]octa[5]ene], 3H,3′H-1λ4,1′-spirobi[[2,1]benzoxathiol], 3H-2λ5-spiro[1,3,2-benzoxaphosphole-2,2′-[1,3,5,2]triazaphosphinine], spiro[4.5]decane, tris[1,2-benzenediolato-(2-)]sulfur, 1,4,6,9,10,13-hexaoxa-5λ6-thiaspiro[4.45.45]tridecane, 5λ6-thiatrispiro[2.1.1.27.15.25.23]tetradecane, and the like.

In the present invention, among the above-listed low dielectric constant insulating materials, a p-oligophenylene derivative which is expressed by the following Formula 2 and in which the atoms having a valency of four or more are spiro carbon atoms, is most preferable.

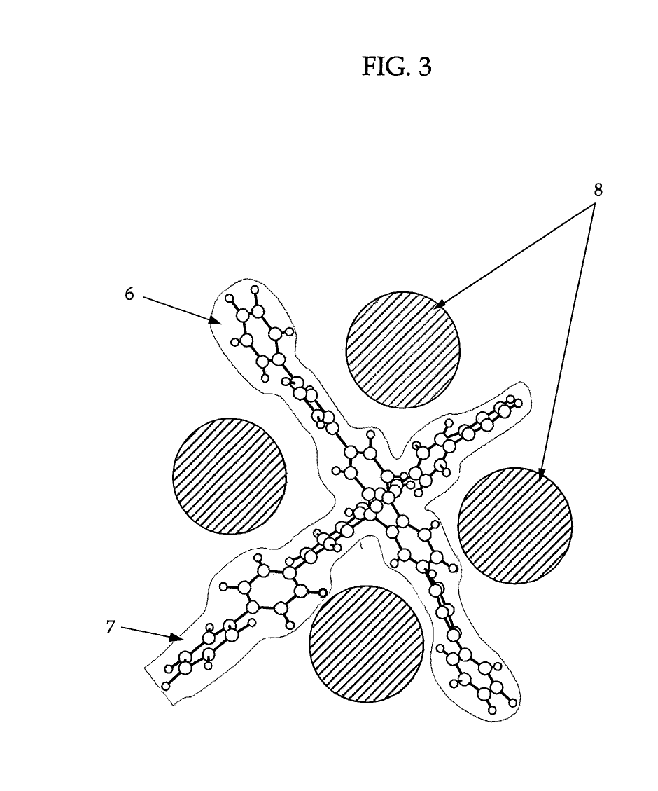

As the two cyclic compounds are orthogonal to each other, in the compound of the low dielectric constant insulating material, four spaces are easily formed around the spiro carbon atom. Use of such compounds is advantageous in that, when a film or the like is formed using such compounds, the film or the like effectively attain a low dielectric constant. Regarding the four spaces forming around the spiro carbon atom, it was found that large spaces formed in four places by molecular orbital computation (MOPAC) as shown in FIG. 3, where, for example, a p-oligophenylene derivative was used, and in which a p-oligophenyl was bonded to the spiro carbon atom, and all of the “R” and “R¹” through “R¹²” were hydrogen atoms and l=m=n=o=1, in the following Formula 2. In FIG. 3, moreover, the large spheres represent the carbon atoms, and the small spheres represent the hydrogen atoms. In this p-oligophenylene derivative, as can be also seen FIG. 3, the p-phenylene chains “6” and “7” extend in orthogonal directions, spaces “8” are hence formed between the p-phenylene chains, and as a result, the compound is less dense and has a lower dielectric constant.

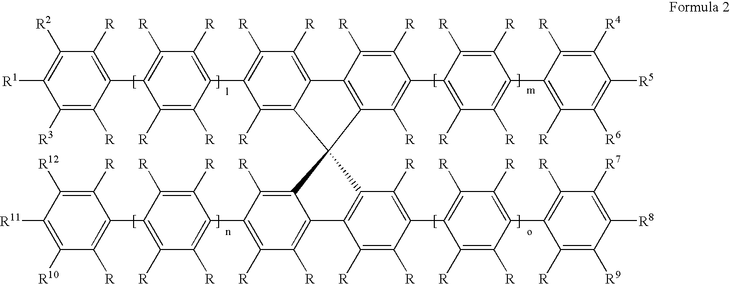

In the above Formula 2, “R” expresses a hydrogen atom or a substituent, and the “R”s may be identical or different.

The substituent is not particularly limited and may be appropriately selected in accordance with the object. Examples include halogen atoms, alkoxyl groups, aryloxy groups, cyano groups, alkyl groups, aryl groups, arylamino groups, siloxane-bond-containing groups, and the like.

Examples of the halogen atom are fluorine, chlorine, bromine, and iodine.

With regard to the alkoxyl group, an alkyl portion thereof may be a cyclic alkyl, and the number of carbon atoms is preferably 1 to 30. Examples include methoxy, ethoxy, propoxy, butoxy, pentoxy, cyclobutoxy, cyclopentoxy, and the like.

With regard to the aryloxy group and the arylamino group, an aryl portion thereof may be, for example, benzyl, toluyl, or the like.

Examples of the alkyl group are methoxy, ethoxy, propoxy, butoxy, pentoxy, cyclobutoxy, cyclopentoxy, and the like.

Examples of the aryl group are benzyl, toluyl, and the like.

In the above Formula 2, each of “R¹” through “R¹²” expresses a substituent having a thermosetting group. The substituent is not particularly limited, and examples include those listed above. The thermosetting group is a group which crosslinks due to heat, and examples thereof are a hydroxyl group, a carboxyl group, an amino group, an aldehyde group, and the like. Instead of including a thermosetting group, “R¹” through “R¹²” may be a thermosetting group itself.

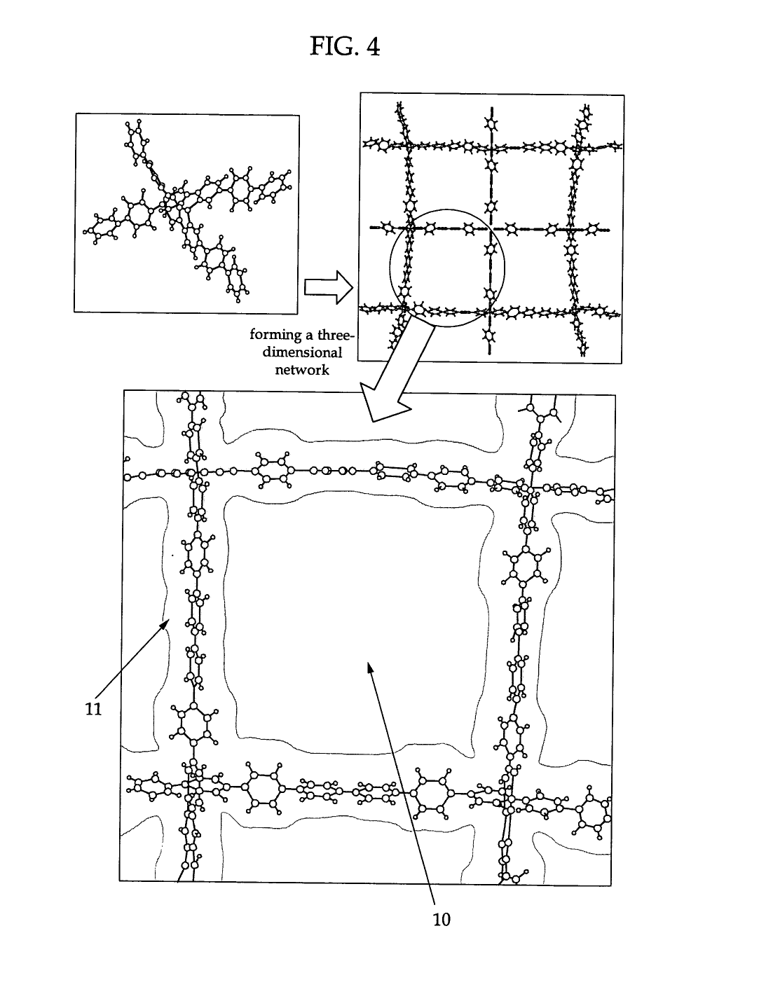

When “R¹” through “R¹²” contain a thermosetting group, as shown in FIG. 4, a three-dimensional network having electron clouds “11” and forming spaces at molecular level “10” is easily formed due to the crosslinking of the thermosetting groups. Thus, this is preferable in that the heat resistance, the mechanical strength, and the like can be markedly improved.

In the above Formula 2, “l”, “m”, “n”, and “o” express integers of 0 or more. The values of “l”, “m”, “n”, and “o” are not particularly limited, and can be appropriately selected in accordance with the object. The values of “l”, “m”, “n”, and “o” being the same is advantageous in that, as shown in FIG. 4, the configurations of the spaces formed around the carbon having a valency of four or more can be formed regularly, such as in square shapes or the like. Further, “l”, “m”, “n”, and “o” being different values is advantageous in that the configurations and sizes of the spaces formed around the carbon having a valency of four or more can be varied freely, and the properties, such as the dielectric constant and the like, can easily be adjusted to desired degrees.

The low dielectric constant insulating material of the present invention can be synthesized in accordance with known methods in the art. For example, the material can be synthesized in accordance with methods disclosed in the publications cited in the following publications, or the like: Y. Geng, D. Katsis, S. W. Culligan, J. J. Ou, S. H. Chen, L. J. Rothberg, Chem. Mater. 14,463 (2002), I. A. Abu-Yousef, A. S. Hay, Synth. Commun., 29, 2915 (1999), J. G. Smith, R. T. Wikman, Tetrahdron, 30, 2603 (1974), E. Buchta, G. Loew, Liebigs Ann. 597, 123 (1955), E. F. Bonner, A. G. Finkensieper, E. I. Becker, J. Org. Chem., 18, 426 (1953), R. L. Wu, J. H. Schumm, D. L. Pearson, J. M. Tour, J. Org. Chem. 61, 6906 (1996), F. Steuber, J. Staudigel, M. Stoessel, J. Simmerer, A. Winnacker, H. Spreitzer, F. Weissoertel, J. Salbek, Adv. Mater, 12, 130 (2000), U. Bach, K. DeCloedt, H. Spreitzer, M. Gratzel, Adv. Mater, 12, 130 (2000).

When a film or the like is formed by using the low dielectric constant insulating material of the present invention, the film or the like can be made to be low density and to have a low dielectric constant due to the spaces formed around the atom having a valency of four or more in the low dielectric constant insulating material. In addition, heat resistance, strength and the like can be improved. Moreover, the low dielectric constant insulating material of the present invention and a film formed of the above material have a dielectric constant of 4.1 or less. Thus, the low dielectric constant insulating material of the present invention can be suitably used in devices of which high speed and reliability are required, namely, electronic parts such as highly integrated semiconductor devices, for instance ICs, LSIs, and the like. The material of the present invention is particularly suitably used as an interlayer insulating film of electronic parts.

### Electronic Part

The electronic part of the present invention is not particularly limited as long as the above-described low dielectric constant insulating material is used therefor. The electronic part may include known members in the art, which are appropriately selected as needed.

When the electronic part is a semiconductor element, it is preferable to use the above-described low dielectric constant insulating material as an interlayer insulating film.

In this case, the method of forming the interlayer insulating film is not particularly limited. Examples are known methods, for example, coating methods such as the spin coating method and the like, and deposition methods such as the CVD method and the like. The thickness of the interlayer insulating film is not particularly limited, and can be appropriately selected in accordance with the object. However, a thickness of approximately 0.05 μm to 5 μm is preferable.

The electronic part of the present invention comprises the low dielectric constant insulating material of the present invention, for example, the electric part has the low dielectric constant insulating material of the present invention as the interlayer insulating film. Accordingly, the electronic part of the present invention is excellent in insulating between the respective layers and the like, high-speed, and reliability. For these reasons, the electronic part of the present invention is suitable for a semiconductor element in various fields, for example, a flash memory, a DRAM, an FRAM, a MOS transistor, or the like.

Hereinafter, Examples of the present invention will be described. However, the present invention is not limited to these Examples.

### EXAMPLE 1

The compound expressed by following Structural Formula III was synthesized as a low dielectric constant insulating material of the present invention by the following synthesis scheme in accordance with the known Suzuki coupling reaction. Specifically, 1.6 equivalent of the compound (tetrabromo-9,9′-spirobifluorene) expressed by following Structural Formula I and 1.6 equivalent of the compound expressed by following Structural Formula II were added to 60 equivalent of a 6:4 mixture of toluene and Na₂CO₃ aqueous solution (2 mol). Moreover, 5 mol % of Pd(PPh₃)₄ was added thereto. Note that “Ph” represents a phenyl group. The mixture was reacted for 2 days at 90° C. Thereafter, a large amount of methyl chloride was added, and the organic solution portion was washed in accordance with an ordinary method. After the moisture was removed by MgSO₄ anhydride, heat concentration was carried out, and the resultant substance was purified by column chromatography (silica gel). Note that commercially available products were used as the raw materials of this synthesis. Further, the aforementioned compound expressed by Structural Formula I, and the aforementioned compound expressed by Structural Formula II which was necessary for the Suzuki coupling reaction, were synthesized in accordance with ordinary methods (R. L. Wu et. al., J. Org. Chem., 61, 6906 (1996), M. Grell et. al., Adv. Mater, 11, 671 (1999)).

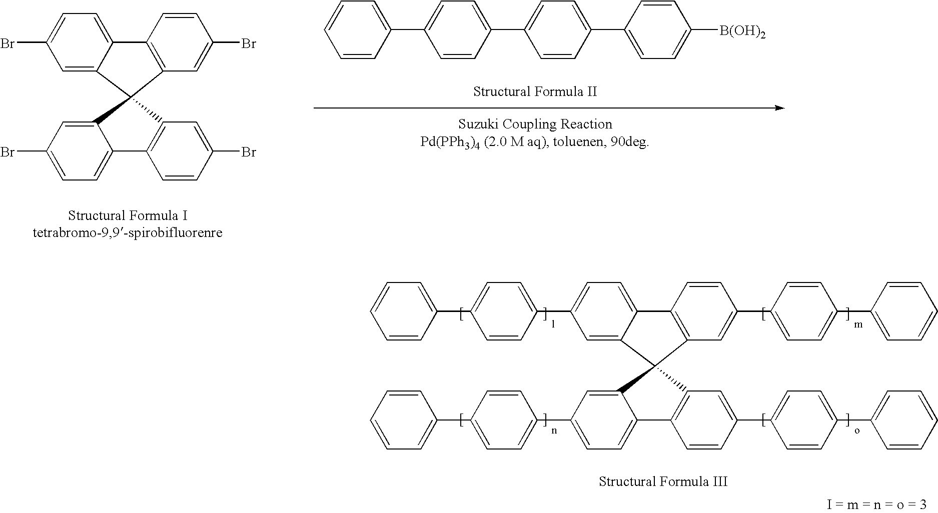

A chloroform 1% by mass solution of the low dielectric constant insulating material of the present invention, which was synthesized as described above and is expressed by above Structural Formula III, was prepared. The solution was spin coated on a substrate at 5000 rpm, was dried, and was pre-cured for 5 minutes at 220° C. As the after-curing process, the coated substrate was left to stand for 5 hours at 200° C. in a nitrogen atmosphere of an oxygen concentration of 10 ppm or less, and then an insulating film was formed.

Gold was deposited on the formed insulating film. The dielectric constant was measured at 1 MHz, and it was found that the dielectric constant of the insulating film was 2.3. Further, the starting temperature of thermal decomposition was 320° C.

### EXAMPLE 2

The low dielectric constant insulating material of the present invention expressed by following Formula 3 was synthesized in the same way as in Example 1, except that compounds, in which an amino group was substituted and an aldehyde group was substituted at the end of the compound expressed by above Structural Formula II, were used.

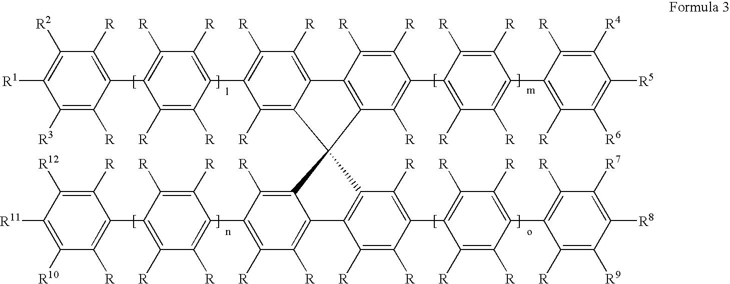

In the above Formula 3, “R” expresses a hydrogen atom. “R¹” and “R¹¹” each express an amino group (NH₂). “R⁵” and “R⁸” each express an aldehyde group (CHO). “R²”, “R³”, “R⁴”, “R⁶”, “R⁷”, “R⁹”, “R¹⁰”, and “R¹²” each express a hydrogen atom. Further, “l”=“m”=“n”=“o”=3.

A chloroform 1% by mass solution of the low dielectric constant insulating material of the present invention, which was synthesized as described above and is expressed by the above formula, was prepared. The solution was spin coated on a substrate at 5000 rpm, was dried, and was pre-cured for 5 minutes at 220° C. As the after-curing process, the coated substrate was left to stand for 5 hours at 200° C. in a nitrogen atmosphere of an oxygen concentration of 10 ppm or less, and an insulating film was formed.

Gold was deposited on the formed insulating film. The dielectric constant was measured at 1 MHz, and it was found that the dielectric constant of the insulating film was 1.7. Further, the starting temperature of thermal decomposition was 450° C.

### EXAMPLE 3

The low dielectric constant insulating material of the present invention was synthesized and an insulating film was formed in the same way as in Example 2, except that “l”=“m”=“n”=“o”=b 5.

Gold was deposited on the formed insulating film. The dielectric constant was measured at 1 MHz, and it was found that the dielectric constant of the insulating film was 1.4. Further, the starting temperature of thermal decomposition was 450° C.

### EXAMPLE 4

An insulating film was formed in the same way as in Example 3, except that the low dielectric constant insulating material of the present invention synthesized in Example 3 was mixed together with a two-functional silicone resin in a mass ratio of 1:1 and the two-functional silicone resin was bonded to the low dielectric constant insulating material.

Gold was deposited on the formed insulating film. The dielectric constant was measured at 1 MHz, and it was found that the dielectric constant of the insulating film was 1.5. Further, the starting temperature of thermal decomposition was 460° C.

### EXAMPLE 5

The low dielectric constant insulating material of the present invention expressed by following Formula 4 was synthesized in the same way as in Example 1, except that the compound expressed by above Structural Formula II was replaced with a compound having a spiro carbon atom having the structure positioned at the four corners of the following formula.

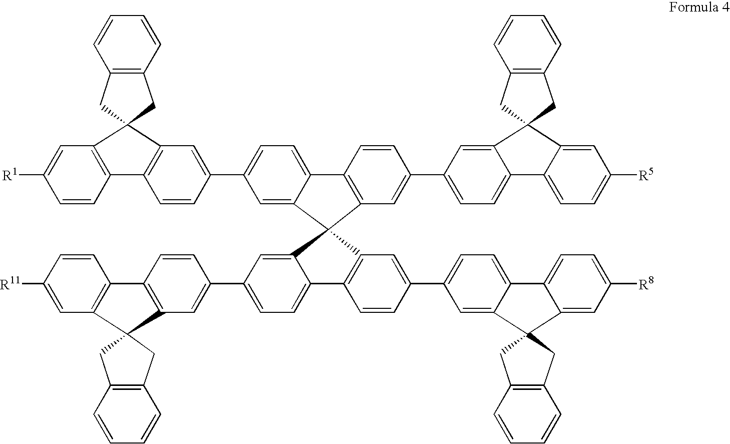

In Formula 4, “R¹”, “R⁵”, “R⁸” and “R¹¹” express hydrogen atoms.

A chloroform 1% by mass solution of the low dielectric constant insulating material of the present invention, which was synthesized as described above and is expressed by the above formula, was prepared. The solution was spin coated on a substrate at 5000 rpm, was dried, and was pre-cured for 5 minutes at 220° C. As the after-curing process, the coated substrate was left to stand for 5 hours at 200° C. in a nitrogen atmosphere of an oxygen concentration of 10 ppm or less, and an insulating film was formed.

Gold was deposited on the formed insulating film. The dielectric constant was measured at 1 MHz, and it was found that the dielectric constant of the insulating film was 2.5. Further, the starting temperature of thermal decomposition was 360° C.

### EXAMPLE 6

The low dielectric constant insulating material of the present invention expressed by following Formula 5 was synthesized in the same way as in Example 5, except that compounds, in which amino groups were substituted and aldehyde groups were substituted at the ends of the aforementioned compound having a spiro carbon atom of the structure positioned at the four terminals, were used.

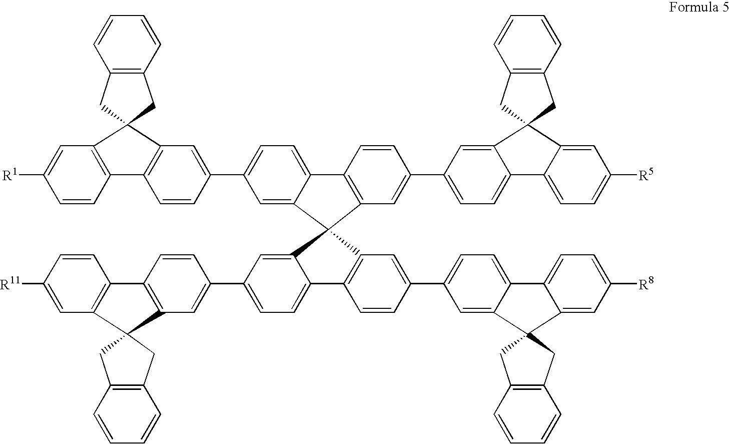

In Formula 5, “R¹” and “R¹¹” express amino groups (NH₂), and “R⁵” and “R⁸” express aldehyde groups (CHO).

A chloroform 1% by mass solution of the low dielectric constant insulating material of the present invention, which was synthesized as described above and is expressed by the above Formula 5, was prepared. The solution was spin coated on a substrate at 5000 rpm, was dried, and was pre-cured for 5 minutes at 220° C. As the after-curing process, the coated substrate was left to stand for 5 hours at 200° C. in a nitrogen atmosphere of an oxygen concentration of 10 ppm or less, and an insulating film was formed.

Gold was deposited on the formed insulating film. The dielectric constant was measured at 1 MHz, and it was found that the dielectric constant of the insulating film was 1.8. Further, the starting temperature of thermal decomposition was 460° C.

### EXAMPLE 7

An insulating film was formed in the same way as in Example 6, except that the low dielectric constant insulating material of the present invention synthesized in Example 6 was mixed together with a 2-functional silicone resin in a mass ratio of 1:1 and the two functional silicone resin was bonded to the low dielectric constant insulating material.

Gold was deposited on the formed insulating film. The dielectric constant was measured at 1 MHz, and it was found that the dielectric constant of the insulating film was 1.6. Further, the starting temperature of thermal decomposition was 470° C.

As can be understood from the above, a film formed by using the low dielectric constant insulating material of the present invention has a low dielectric constant, excellent heat resistance, and high strength, and can be particularly suitably used as an interlayer insulating film in electronic parts such as semiconductor elements or the like.

In accordance with the present invention, there is provided a low dielectric constant insulating material which overcomes the drawbacks of the prior art, which contributes to high-speed propagation of signals, and which is suitable as a material for multilayer circuit wirings in an electronic part such as a semiconductor element or the like, and there is provided an electronic part using the low dielectric constant insulating material.

What is claimed is:

1. A low dielectric constant insulating material comprising:
an atom having a valency of four or more; and
at least two cyclic compounds forming a cyclic structure with the atom having a valency of four or more.

2. A low dielectric constant insulating material according to claim 1, wherein the atom having a valency of four or more is selected from a carbon atom, a silicon atom, a nitrogen atom, a phosphor atom and a sulfur atom.

3. A low dielectric constant insulating material according to claim 1, wherein the atom having a valency of four or more is a spiro atom.

4. A low dielectric constant insulating material according to claim 1, wherein the atom having a valency of four or more is in sp3 valency state.

5. A low dielectric constant insulating material according to claim 1, wherein the cyclic compound has two benzene skeletons, each of which has a carbon atom at a portion thereof, and the carbon atom of one benzene skeleton bonds with the carbon atom of the other benzene skeleton.

6. A low dielectric constant insulating material according to claim 1, wherein the cyclic compound has a skeleton expressed by Formula 1: 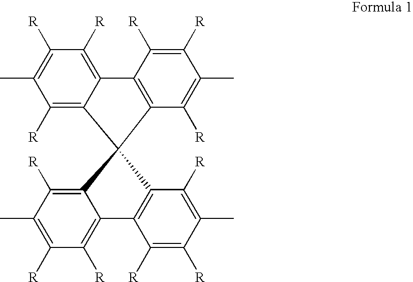
where “R” expresses one of a hydrogen atom and a substituent.

7. A low dielectric constant insulating material according to claim 1, wherein at least one of an aromatic compound and an insulating resin bonds with the cyclic compound.

8. A low dielectric constant insulating material according to claim 7, wherein the at least one of an aromatic compound and an insulating resin is selected from a p-phenylene derivative and a silicone resin.

9. A low dielectric constant insulating material according to claim 1, wherein the low dielectric constant insulating material is a p-oligophenylene derivative expressed by Formula 2, and the atom having a valency of four or more is a spiro carbon atom: 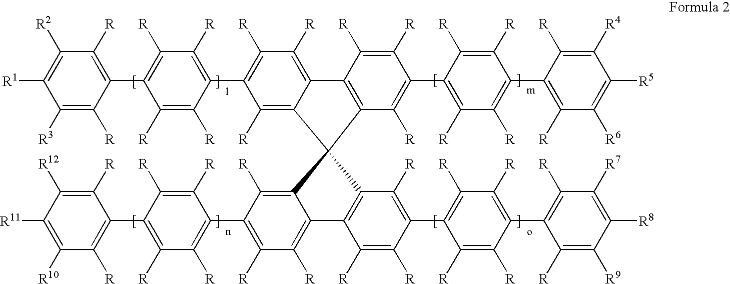
where “R” expresses one of a hydrogen atom and a substituent, each of “R¹” through “R¹²” expresses a substituent including a thermosetting group, and “l”, “m”, “n”, and “o” are integers of 0 or more.

10. An electronic part comprising,
a low dielectric constant insulating material,
wherein the low dielectric constant insulating material comprises,
an atom having a valency of four or more, and
at least two cyclic compounds forming a cyclic structure with the atom having a valency of four or more.

11. An electronic part according to claim 10, wherein the atom having a valency of four or more is selected from a carbon atom, a silicon atom, a nitrogen atom, a phosphor atom and a sulfur atom.

12. An electronic part according to claim 10, wherein the atom having a valency of four or more is a spiro atom.

13. An electronic part according to claim 10, wherein the atom having a valency of four or more is in sp3 valency state.

14. An electronic part according to claim 10, wherein the cyclic compound has two benzene skeletons, each of which has a carbon atom at a portion thereof, and the carbon atom of one benzene skeleton bonds with the carbon atom of the other benzene skeleton.

15. An electronic part according to claim 10, wherein the cyclic compound has a skeleton expressed by Formula 1: 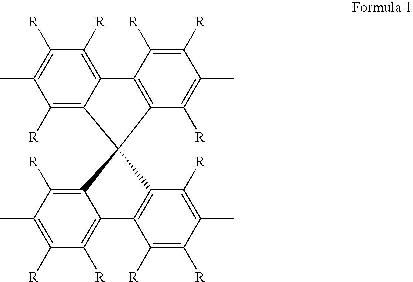
where “R” expresses one of a hydrogen atom and a substituent.

16. An electronic part according to claim 10, wherein at least one of an aromatic compound and an insulating resin bonds with the cyclic compound.

17. An electronic part according to claim 16, wherein the at least one of an aromatic compound and an insulating resin is selected from a p-phenylene derivative and a silicone resin.

18. An electronic part according to claim 10, wherein the low dielectric constant insulating material is a p-oligophenylene derivative expressed by Formula 2, and the atom having a valency of four or more is a spiro carbon atom: 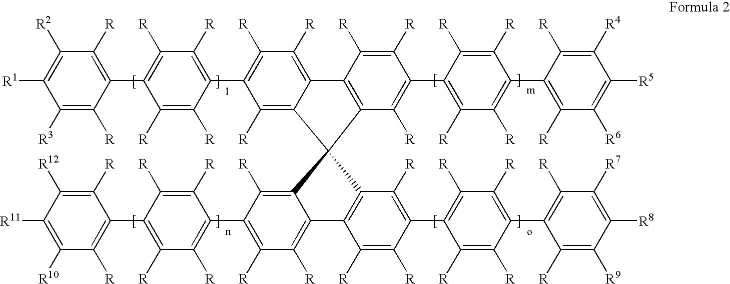
where “R” expresses one of a hydrogen atom and a substituent, each of “R¹” through “R¹²” expresses a substituent having a thermosetting group, and “l”, “m”, “n”, and “o” are integers of 0 or more.

19. An electronic part according to claim 10, wherein the electronic part is a semiconductor device, and the low dielectric constant insulating material is used as an interlayer insulating film.
